(19) United States
(12) Patent Application Publication
(10) Pub. No.: US 2009/0315825 A1
(43) Pub. Date: Dec. 24, 2009

(54) INFRARED VIRTUAL, INVISIBLE COMPUTER KEYBOARD AND MOUSE

(76) Inventor: John Cauchi, (US)

Correspondence Address: John, 1634 Canary Drive, Sunnyvale, CA, 94087, US

(21) Appl. No.: 12/144,744

(22) Filed: Jun. 24, 2008

(51) Int. Cl. G09G 5/00

(52) U.S. Cl. 345/156

(57) ABSTRACT

New design for an infrared virtual, invisible computer keyboard and mouse for a mice and keyboard less computer is presented. The current invention uses the fact that the infrared spectrum of human fingers can be changed when irradiated with low power diodes. Using this fact, the present invention presents a method where a human finger's infrared spectrum, irradiated by an array of infrared diodes, is picked up by infrared sensors installed either in stand alone mode, on top of the computer display or directly into the computer display. The computer then uses the finger infrared spectrums picked by the infrared sensors to created virtual, invisible mouse and keyboard where words can drawn in the air and mouse commands are also given by moving the finger in different directions in the air.

### BACKGROUND OF THE INVENTION

The present invention relates to computer mice and keyboards. Computer mice 100 (FIG. 1) are used to interact with the computer to drive specific instruction such as opening programs, files, folders, interact with websites in the internet (Copy and paste information from a website) and navigate on opened programs such as word (word processing) and excel (data processing).

Computer keyboards 110 (FIG. 1) are used to type in data into both the word and data processing programs, which are displayed on a computer monitor 120 (FIG. 1) and for a variety of other data entry functions.

So basically both computer mice and keyboards are the only gateways for humans to interact with the computers. The biggest trade off of the keyboard and mice is that humans have to use their hands all the time to interact with the computer. The heavy usage of the hands leads eventually to fatigue of the hand ligaments or wrist leading humans to develop what is known as carpal tunnel syndrome, a medical condition in which the median nerve is compressed at the wrist.

The present invention intends to develop a new method for interacting with the computer that doesn't involve the heavy usage of the human hands.

The new design is called design for an infrared virtual, invisible computer keyboard and mouse

### SUMMARY

The invention is defined by the appended claims which are incorporated into this section in their entirety. The rest of this section summarizes some features of the invention. Some embodiments of the current invention provide alternative methods for humans to interact with the computer. The current invention uses the design and method outlined on patent application Ser. No. 29/319,388 with title of: SILENT OR LOUD 3D INFRARED FUTURISTIC COMPUTER MICE AND KEYBOARD DESIGN FOR A MICE&KEYBOARD LESS COMPUTER. That invention uses the fact that each word spoken by humans has a distinctive three dimensional (3D) pattern of the mouth and face 130 (FIG. 2) and unique infrared spectrum when irradiated with an infrared or lower power diode array 140 (FIG. 3). Using that fact, that invention presents a method where the facial expression, irradiated by an array of infrared or low power diodes 140 (FIG. 3), of the spoken word is picked up by highly sensitive infrared sensors 150 (FIG. 3) installed either in stand alone mode, on top of the computer display 160 (FIG. 3) or directly into the computer display. The infrared sensors along with a graphics card, microprocessor and software translates any spoken word silent or loud into computer commands by creating a 3D image of the spoken word and matching to a pre-loaded 3D images or by matching the unique infrared spectrums of the spoken word to pre-loaded spectrums of the spoken word. This new invention uses any human hand finger, instead of the mouth, which is also irradiated by the low power or infrared diode array as the means to send commands to the computer. This new invention also will facilitate the interaction of humans and computers without the use of a keyboard or mouse.

### BRIEF DESCRIPTION OF THE FIGURES

FIG. 1 Prior art of a standard computer with monitor, mouse and keyboard.

FIG. 2 Prior art of a side ways spoken word facial expression for the word NO showing the protruding lips.

FIG. 3 Drawing showing a computer without a keyboard or mouse and showing infrared sensor array and infrared or low power diode array.

FIG. 4 Prior art showing infrared spectrum, different temperatures, of a still human finger and infrared spectrum when the finger is irradiated by an infrared or low power diode. It also shows temperature bar from 75 F (Degrees Fahrenheit) to 105 F to judge the temperature.

FIG. 5 Prior art showing a diode's beam spread and spot size.

FIG. 6 Drawing showing a virtual or invisible mouse created by the present invention.

FIG. 7 Drawing showing a virtual or invisible keyboard created by the present invention.

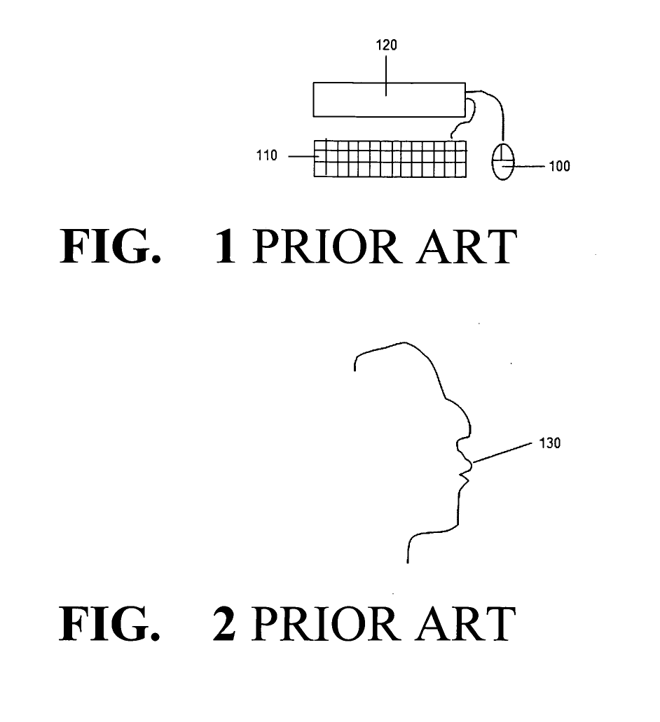

### DESCRIPTION OF THE INVENTION

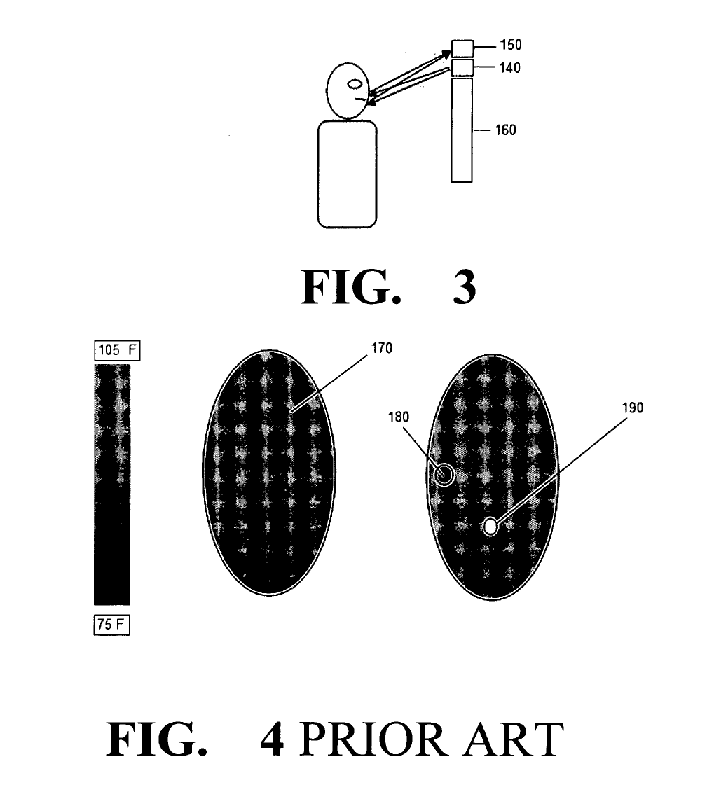

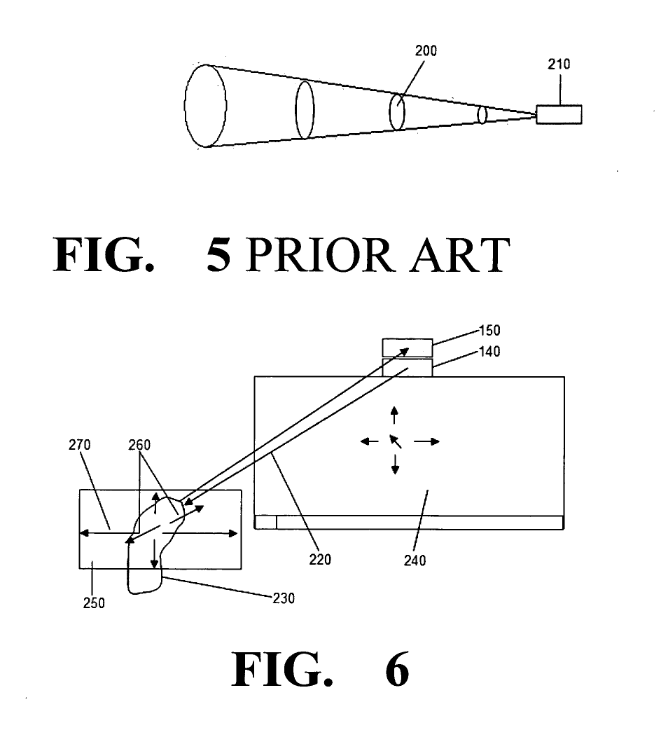

The invention will make use of highly sensitive infrared sensors 150 (FIG. 5) which will detect the natural infrared radiation of any human finger 230 (FIG. 6). Additionally, an array of infrared or low power diodes 140 (FIG. 6) will send beams of light 220 (FIG. 6) towards the finger used to give commands. Once the infrared lights hit the human finger, the natural infrared spectrum of the finger 170 (FIG. 4) will change according to where the infrared lights hit the finger. For instance, the farthest part of the finger 180 (FIG. 4) will look different than closer to the front 190 (FIG. 4) since they are at different distances from the infrared diodes array. Also, using the fact that a diode light beam 200 (FIG. 5) will spread wider the longer in travels, the light beam hitting the front of the finger is narrower than the beam hitting the farthest part of the finger. The narrower beam has more concentration of energy than the wider beam. Thus, the narrower beam will heat up a surface faster than the wider beam. So, on the infrared sensor array 150 (FIG. 6), on a still finger, the area-around the front of the finger 190 (FIG. 4) hit by the narrower beam will appear hotter than the area hit by the wider beam on the farther part of the finger 180 (FIG. 4). Also, as the finger moves back and forth the shape of the infrared or low power diode beams become either an ellipse or a circle. This fact will be used to give the mouse commands of select and un-select commands.

The mouse commands for this invention are shown in FIG. 6. Once the finger is in front of the computer 240 (FIG. 6), the array of infrared or low power diodes 140 (FIG. 6) will irradiate the finger with an array of light beams 220 (FIG. 6). This will change the finger's normal infrared spectrum which will be picked up by the array of infrared sensors 150 (FIG. 6). As soon as the array of infrared sensors 150 (FIG. 6) pick the infrared spectrum of the finger, the sensors will send this signal to the computer to check if the finger's spectrum image matches preloaded spectrum images of human fingers. If there is a match, then the computer will accept commands from the human finger detected, this is done so that only the finger can be used for commands. Once the human finger is recognized, the computer will calculate the distance of the finger to the computer by using the different spot sizes of the diode array beams. Once the distance is calculated, the computer will create a virtual or invisible mouse or pad 250 (FIG. 6) in the air where computer finger commands can be used. For Instance, to select or un-select the finger can be moved back and forth 260 (FIG. 6). As the finger moves back and forth, besides having the different spot sizes of the diode array beams, the beam shape changes from a circle to an ellipse, which gives this particular movement, back and forth, a very distinguishable infrared spectrum. To move selected items/icons on the computer, the finger can be moved left, right, up or down 270 (FIG. 6).

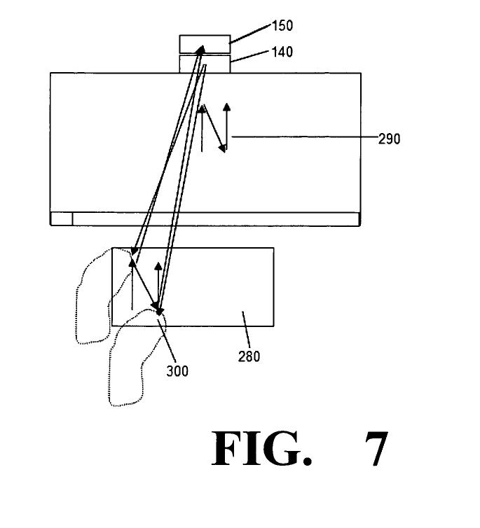

The keyboard FIG. 7 for this invention works the same as the virtual mouse explained in the previous paragraph. The computer recognizes the finger, calculates the distance of finger to computer and then it creates a virtual, invisible keyboard or touch pad in the air where words can be drawn in the air 280 (FIG. 7). The finger movement when the words are being drawn is being tracked by the infrared sensor array 150 which sends this movement to the computer and the computer types the word 290 on the display as the word is being drawn in the air 300. The virtual, invisible keyboard will only appear when programs such as word processing are opened or when data entry is required.

With this new invention, commands that used to be sent through the computer's keyboard and mouse will be sent through infrared virtual, invisible created in the air and using a human finger. Thus, this new invention leads to a future computer without a keyboard or mouse.

1. Design for an infrared virtual, invisible computer keyboard and mouse where a finger is irradiated by low power or infrared diodes which spectrum is picked up by infrared sensors to be able to type and give computer commands in the air.

2. Any device being electronic or not that uses finger movements irradiated by low power diodes which signal is detected by infrared sensors to give commands.
